(19) United States
(12) Patent Application Publication
(10) Pub. No.: US 2023/0368117 A1
(43) Pub. Date: Nov. 16, 2023

(54) VIRTUAL ORGANIZATION PROCESS SIMULATOR

(71) Applicant: SAP SE, Walldorf (DE)

(72) Inventors: Jeffrey P. Durnwald, Dahlonega, GA (US); Ivan Reyes, Atlanta, GA (US); Prasad Goswami, Roswell, GA (US); James Frederick Beutel, Gainesville, GA (US)

(21) Appl. No.: 17/744,183

(22) Filed: May 13, 2022

(51) Int. Cl. G06Q 10/06; G06T 13/20

(52) U.S. Cl. CPC G06Q 10/067; G06Q 10/0637; G06T 13/20

(57) ABSTRACT

In an example embodiment, a virtual organization process simulator is provided that is capable of simulating organization operations for complex organization processes when actual organization systems are not available. Large operations are able to be visualized at scale and various “what-if” scenarios can be reproduced in the simulator to provide a user with insight into a value of utilizing certain solutions, such as Enterprise Resource Planning (ERP) software. Engaging virtual world visualizations can also be provided, with story-telling walkthroughs.

### TECHNICAL FIELD

This document generally relates to systems and methods for organization processes. More specifically, this document relates to a virtual organization process simulator.

### BACKGROUND

Organization processes (sometimes called business processes, despite them not being limited to businesses) are collections of tasks and activities that, when performed by people or systems in a structured environment, produce an outcome that contributes to an organization's goals. Organization process structures can be simple or complex, based on the elements involved in the process.

### BRIEF DESCRIPTION OF DRAWINGS

The present disclosure is illustrated by way of example and not limitation in the figures of the accompanying drawings, in which like references indicate similar elements.

FIG. 1 is a block diagram illustrating a system for simulating an organization process, in accordance with an example embodiment.

FIG. 2 is a block diagram illustrating portions of the system, comprising an architecture for simulating organization processes, in accordance with an example embodiment.

FIG. 3 is a screen capture of a user interface screen depicting a visual modeling interface with a business line manager abstraction level applied, according to an example embodiment.

FIG. 4 depicts the business analyst modeling view for a compliance perspective, according to an example embodiment.

FIG. 5 is a sequence diagram illustrating a method of setting up a simulation of an organization process, in accordance with an example embodiment.

FIG. 6 is a sequence diagram illustrating a method of creating a world, in accordance with an example embodiment.

FIG. 7 is a sequence diagram illustrating a method of creating a story, in accordance with an example embodiment.

FIG. 8 is a block diagram illustrating a document flow for the downstream diesel delivery, in accordance with an example embodiment.

FIG. 9 is a block diagram illustrating a process flow for an experience, in accordance with an example embodiment.

FIG. 10 is a block diagram illustrating a simulation model, where the steps of the corresponding organization models complete without disruption, in accordance with an example embodiment.

FIG. 11 is a diagram illustrating a plurality of data structures used to implement the simulations, in accordance with an example embodiment.

FIG. 12 is a flow diagram illustrating a method of simulating an organization process, in accordance with an example embodiment.

FIG. 13 is a block diagram illustrating an architecture of software, which can be installed on any one or more of the devices described above.

FIG. 14 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows discusses illustrative systems, methods, techniques, instruction sequences, and computing machine program products. In the following description, for purposes of explanation, numerous specific details are set forth in order to provide an understanding of various example embodiments of the present subject matter. It will be evident, however, to those skilled in the art, that various example embodiments of the present subject matter may be practiced without these specific details.

In an example embodiment, a virtual organization process simulator is provided that is capable of simulating organization operations for complex organization processes when actual organization systems are not available. Large operations are able to be visualized at scale and various “what-if” scenarios can be reproduced in the simulator to provide a user with insight into a value of utilizing certain solutions, such as Enterprise Resource Planning (ERP) software. Engaging virtual world visualizations can also be provided, with story-telling walkthroughs.

The virtual organization process simulator reproduces complex interactions between agents in a manner that allows dynamic behaviors to be represented, unlike in other solutions such as linear event editors. In an example embodiment, this has taken the form of a visual programming language that has concepts such as variables, consumable resources, actions, blocking resources, entities, and so forth. This gives the user the potential to recreate entire factory floors, for example, with interdependent processes, as well as the possibility of displaying the effect of a “wild card” that could disrupt the current state of the simulation.

The concept of a “world” may also be introduced. Here, a world is a three-dimensional (3D) visualization that can be customized and configured by the user with specific building types, agents (vehicles, planes, trains, people, etc.), informational popups, animations, billboards, location titles, environmental backgrounds, and so forth. The world reacts to events that the simulator produces by creating a visualization, such as a truck moving between facilities with dynamic navigation, a boat leaving a harbor and following a fixed path, a scene camera moving to a specified location, a popup displaying information about a location or event, and so forth.

The concept of a “story” may also be introduced. Here, a story comprises the narrative details that can be created and orchestrated by simulator events or actions in the world. This can include descriptions or details about characters or tasks to be completed. It can also include images or videos uploaded by the user that support the narrative.

The final product that the user can edit and play may be termed an “experience,” which comprises a story, world, and simulation. There are unique identifiers for each component that are used to associate with the experience. An experience browser can be provided that allows users to navigate through experiences created by other users.

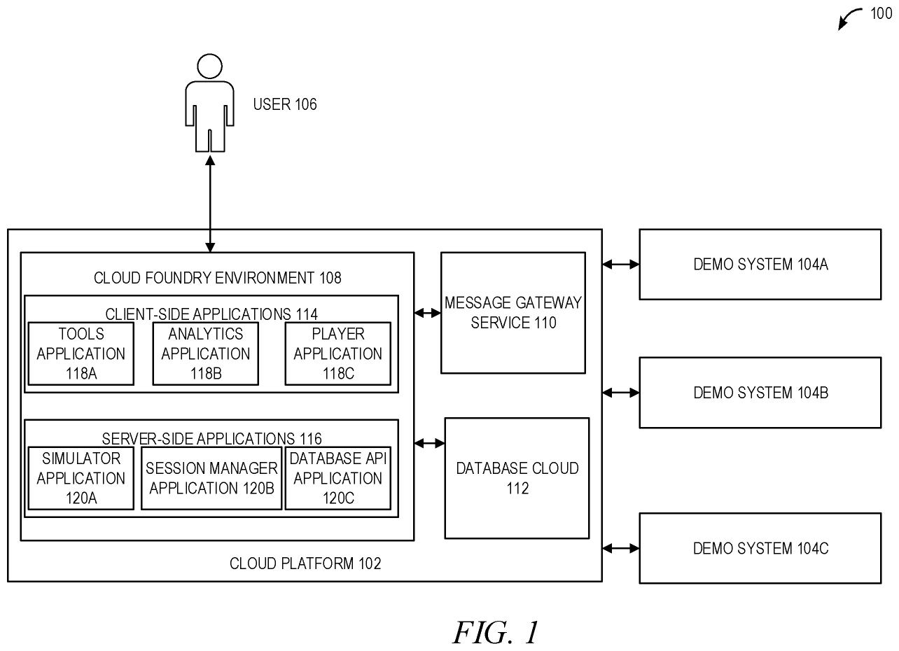

FIG. 1 is a block diagram illustrating a system 100 for simulating an organization process, in accordance with an example embodiment. The system includes a cloud platform 102, one or more demo systems 104A, 104B, 104C, and a user 106. The cloud platform 102 includes a Cloud Foundry environment 108, a message gateway service 110, and a database cloud 112.

Cloud Foundry is an open source, multi-cloud application platform as a service that allows for continuous delivery as it supports a full application development lifecycle, from initial deployment through testing stages to deployment. Cloud Foundry utilizes a container-based architecture that runs application in any programming language over a variety of cloud service providers.

Here, the Cloud Foundry environment 108 is used to create the virtual organization process simulator using a set of client-side applications 114 and a set of server-side applications 116. The client-side applications 114 include a tools application 118A, an analytics application 118B, and a player application 118C. The server-side applications 116 include a simulator application 120A, a session manager application 120B, and a database application program interface (API) application 120C.

Demo systems 104A, 104B, 104C include various network programs that may be utilized in ERP systems, procurement and supply chain management, and human capital management (HCM). The demo systems 104A, 104B, 104C may interact with the Cloud Foundry environment 108 via the message gateway service 110 for purposes of illustrating various “what if” scenarios, such as what a world would operate like if the user were to sign up for one of the demo systems 104A, 104B, 104C.

In an example embodiment, the database cloud 112 may include an in-memory database. An in-memory database (also known as an in-memory database management system) is a type of database management system that primarily relies on main memory for computer data storage. It is contrasted with database management systems that employ a disk storage mechanism. In-memory databases are traditionally faster than disk storage databases because disk access is slower than memory access. One example in-memory database is the HANA® database from SAP SE, of Walldorf, Germany.

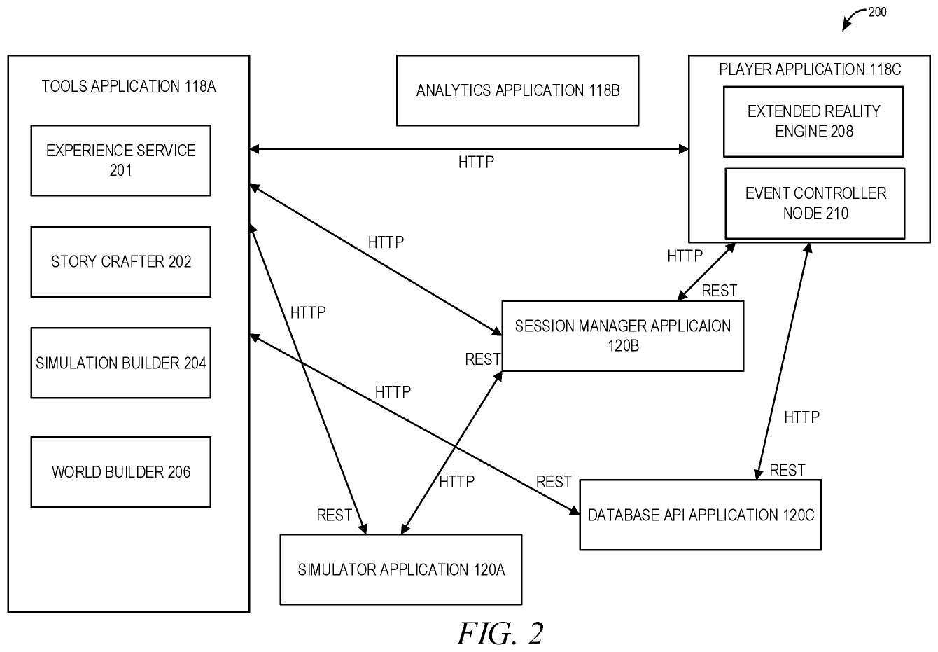

FIG. 2 is a block diagram illustrating portions of a system 200, comprising an architecture for simulating organization processes, in accordance with an example embodiment. More particularly, the tools application 118A, analytics application 118B, player application 118C, simulator application 120A, session manager application 120B, and database API application 120C are depicted, as well as the interactions among them. Tools application 118A includes an experience service 201, a story crafter 202, a simulation builder 204, and a world builder 206. Player application 118C contains an extended reality engine 208 and an event controller node 210.

Communications among the components are performed via Hypertext Transfer Protocol (HTTP). Server-side applications, such as simulator application 120A, session manager application 120B, and database API application 120C, have these HTTP communications converted to Representational State Transfer (REST) prior to receiving them.

The simulator application 120A may run as a server-side application and may operate a discrete event simulator. The discrete event simulator is time based and is able to replicate the operation of an organization process. Thus, for example, once an organization process is setup in the simulator application 120A, the simulator application is able to simulate the organization process progressing forwards in time, generating and reacting to hypothetical events. Time can also be made to pass more quickly in the simulator application 120A than it would in the real world. For example, the simulator application 120A may simulate 20 months of a particular organization process running, yet do so in only 20 minutes, allowing the user to see results that are far into the future.

These simulations are aware of their surroundings because the discrete event simulator is aware of the actors in all running organization processes, including the availability of resources and facilities. Therefore, limited resources are respected and can impact the execution time of each running process. If there are a limited number of maintenance workers, for example, vehicles will not get serviced in time and they may break down. If there are too many trucks in one location, they may sit around and be underutilized while other locations are constrained. Instead of showing a single survey, the customer experience of a large sample of customers can be modeled and users can be shown the impacts of their choices.

In contrast to prior art solutions, this solution can model the steps of the actual organization processes which allow the simulation engine to bring this to life by interacting with other processes and external events. If the user wants to see the details of the document flow, it is possible to drill into the actual documents created by the model.

By introducing randomness into the simulation, the operations feel more real and allows users to invoke the concept of a “wildcard” to see how the organization processes react to an unforeseen event like a strike or machine outage. Ultimately, by using this concept, users will be able to see a stage with models of their actual operations running with their very personalized actors and behavior. Their products, suppliers, production facilities, and customers can all be modeled so that they can truly experience the value of ERP solutions on their own terms.

The simulator application 120A keeps track of the virtual world and all of its actors, resources, facilities, and processes. As events occur within the simulation, its impact is modeled against the other entities, and results occur through their interactions. Since the focus is on the organization process, the simulation will only focus on events which may impact the actors within the organization simulation that is running. This is known as a discrete events simulator.

Because the core intelligence of the virtual world is maintained in simulator application 120A, the extended reality engine 208 is able to deliver visualizations such as 3D gaming engines, virtual reality, physical hardware devices, or existing Immersive Experience rooms. The extended reality engine 208 responds to events generated by the simulator application 120A and renders a simulation in its native format. Additionally, this extended reality engine 208 can interact with the simulator application 120A by simulating outside events and feed those back into the simulator application 120A. Random events may be supported by utilizing consistent random streams.

The extended reality engine 208 supports bidirectional interactions, allowing for the simulator application 120A to interact with users of the extended reality engine 208, while also allowing the users to interact with the simulator application.

The organization processes are stored in the form of organization process models. These models are the steps of the organization processes used by the simulation to drive the entire experience.

In an example embodiment, the simulator application 120A is a single tenant to support heavy computational processing. It may also be containerized to support quick deployment of environments.

In an example embodiment, organization processes are stored in Business Process Model and Notation (BPMN). Such a standardized programming model, as opposed to, for instance, SQLScript, may be understood by non-technical personas like business analysts. It helps in facilitating “organization level” programming entities such as activities, tasks, decisions (gateways), events, and plain “arrows” (control flow connectors) to specify an execution order of organization processes, rather than, for instance, regular database operations (e.g., SQL/SQLScript), which may be very technical and act on the “raw” database entities (e.g., tables, views, etc.).

In many cases, the various tasks of the organization process model may be completed by human actors, hardware devices, software applications, or various combinations thereof. For example, in a simple example, the organization process model may include a number of tasks, where each task is associated with (e.g., assigned to) a corresponding human user. Thus, actual performance of the various tasks may be performed by the appropriate human user. Nonetheless, in such examples, the simulator application 120A may simulate the actors, including the human ones, and may be designed and executed within the context of a corresponding orchestration engine.

In other example implementations, each task of the organization process model may be associated with, or assigned to, a corresponding hardware and/or software component, which may be enabled to automatically begin, execute, and complete the corresponding task. The user starts to design the desired business process. The user may select a pattern through a design utility. The user can select any combination of elements and patterns. A pattern is a grouping of commonly utilized elements that correspond to a portion of a business process or a sub-process in a business process.

The user can select, drag, and drop any pattern from the user interface to the open page or similarly select a pattern for inclusion in the business process. Upon placement of the pattern, a dialog or similar interface can be initiated through which the user configures the pattern's parameters. The parameters of the pattern can include defining the association of the pattern including related documents, data objects, and artifacts. The parameters can also include elements that define a type or variation of the pattern. The type or variation of the pattern can define the functionality of the pattern and enable a pattern to be tailored for a specific scenario. For example, an approval pattern can be defined by type parameters to specify an approval process sequence (e.g., parallel or sequential), a condition or timing for approval such as a number or threshold of required approvers, or a random or defined approval condition (e.g., every fifth request is approved).

The configuration of the pattern can also include configuring the user interface elements associated with the pattern. The user interface elements are to be displayed in the application being designed for the corresponding aspect of the business process. The user can configure the text, graphics, interfaces, layout, fields, windowing, and similar aspects of the user interface associated with the elements of the pattern being configured. Once the user has completed the configuration of the pattern and the associated user interface elements, the dialog for that pattern can be closed.

A set of user interface suggestions can be presented on the design page or grid that now includes the configured pattern. The user interface suggestions can be suggestions for business process elements, artifacts, other patterns, or similar elements that can be linked or associated with the pattern that has just been configured. Each pattern has a specific set of associations, links, or interrelations with other patterns or business elements. The user interface suggestions provide a quick way for the appropriate types of business elements and patterns to be selected. In one example, the user interface elements may be a series of buttons or activatable menus that are displayed adjacent to nodes on the pattern or similar graphical indicators. Those business elements or patterns that are suggested for each of the nodes or graphical elements are constrained to those that are appropriate for that node, link, or association of the pattern. For example, if a pattern has been selected for an approval process, then the user interface suggestions can provide a set of suggestions including a review pattern, intake pattern, or similar patterns commonly associated with an approval pattern.

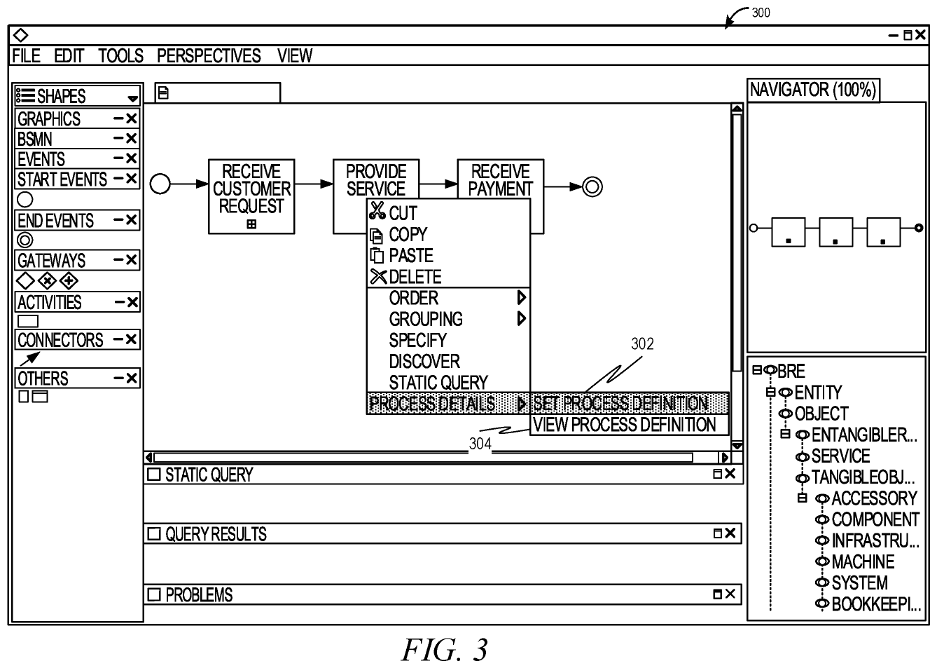

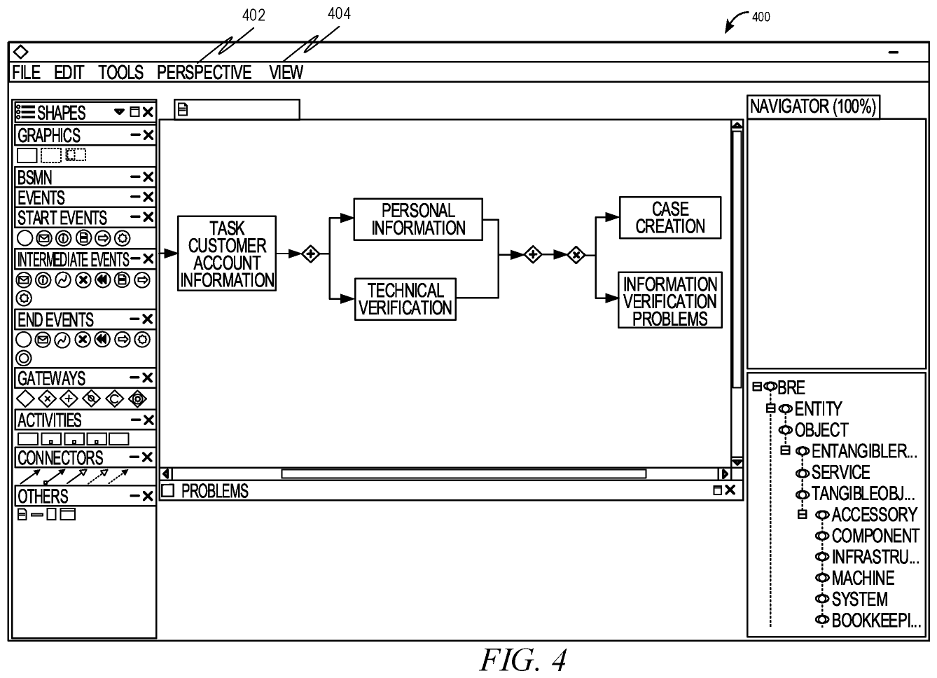

FIG. 3 is a screen capture of a user interface screen depicting a visual modeling interface 300 with a business line manager abstraction level applied, according to an example embodiment. A particular step in the scenario can be detailed through attaching a process by selecting a set process definition 302 menu item as shown in FIG. 3. At any point in time, the user can choose to see a more detailed View of the selected portion of the business scenario by selecting a View process definition 304 menu option, which is then opened for editing in a business analyst modeling View 400, as depicted in FIG. 4.

FIG. 4 depicts the business analyst modeling view 400 for a compliance perspective, according to an example embodiment. The business analyst modeling view 400 supports the full BPMN specification and allows for adding details to process descriptions. The additional details assist in the technical implementation of the process models within target information systems.

A user can easily select the desired modeling perspective or abstraction level through the perspective 402 menu and view 404 menu provided. Providing a unified enterprise meta-model enables integration of the artifacts created in various perspectives/views and thus provides top-down linkage and bottom-up traceability in an organization's process space. Also, separation of concerns in process design through this approach significantly reduces the complexity of process modeling. Furthermore, the formal description of different process aspects enables advanced types of organization process analysis.

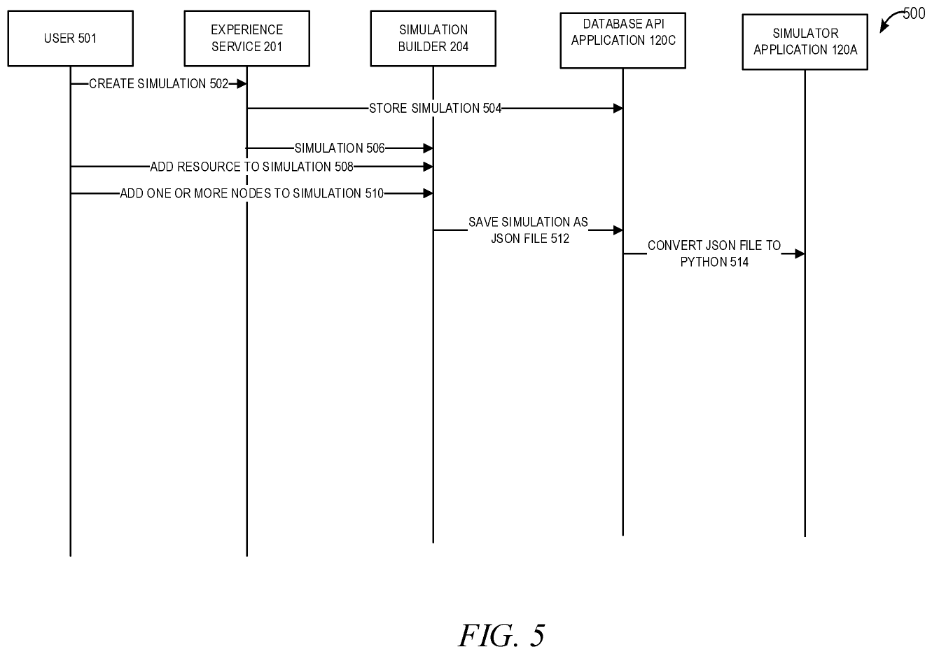

FIG. 5 is a sequence diagram illustrating a method 500 of setting up a simulation of an organization process, in accordance with an example embodiment. The method 500 involves a user 501, the experience service 201, the simulation builder 204, the database API application 120C, and the simulator application 120A. At operation 502, the user creates a simulation using the experience service 201. This may be performed by the user providing the organization process in BPMN to the experience service 201. At operation 504, the simulation may be stored using the database API application 120C. At operation 506, the created simulation may be provided to the simulation builder 204. At operation 508, the user 501 may add a resource to the simulation. This may be a resource that may be utilized by the simulation when the organization process is simulated. At operation 510, the user may add one or more nodes to the simulation. These nodes can add various pieces of information to the simulation, such as delay activity, resource activity, external events, components, debugging information, and general notes.

At operation 512, the simulation builder 204 saves the simulation as a Javascript object notation (JSON) file, via the database API application 120C. At operation 514, the JSON file is converted to Python and sent to the simulator application 120A for simulating.

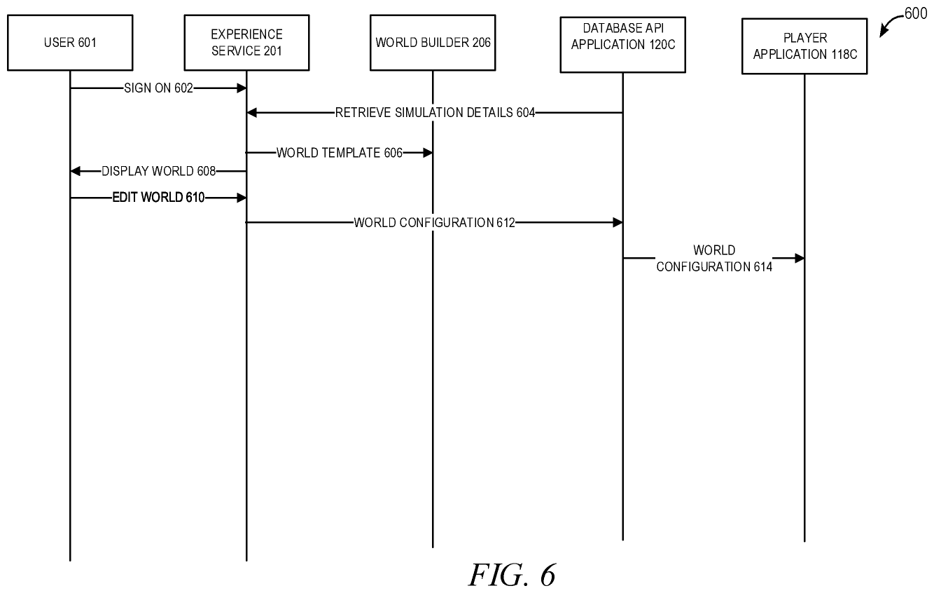

FIG. 6 is a sequence diagram illustrating a method 600 of creating a world, in accordance with an example embodiment. The method 600 involves a user 601, the experience service 201, the world builder 206, the database API application 120C, and the player application 118C. At operation 602, the user signs on to the experience service 201. At operation 604, details about the simulation are retrieved via the database API application 120C. At operation 606, a world template, incorporating the details from the simulation, is sent to the world builder 206. At operation 608, the experience service 201 displays the world to the user 601. At operation 610, the user 601 edits the world. The edits are combined into a world configuration and stored via the database API application 120C at operation 612. Finally, at operation 614, the world configuration is loaded into the player application 118C.

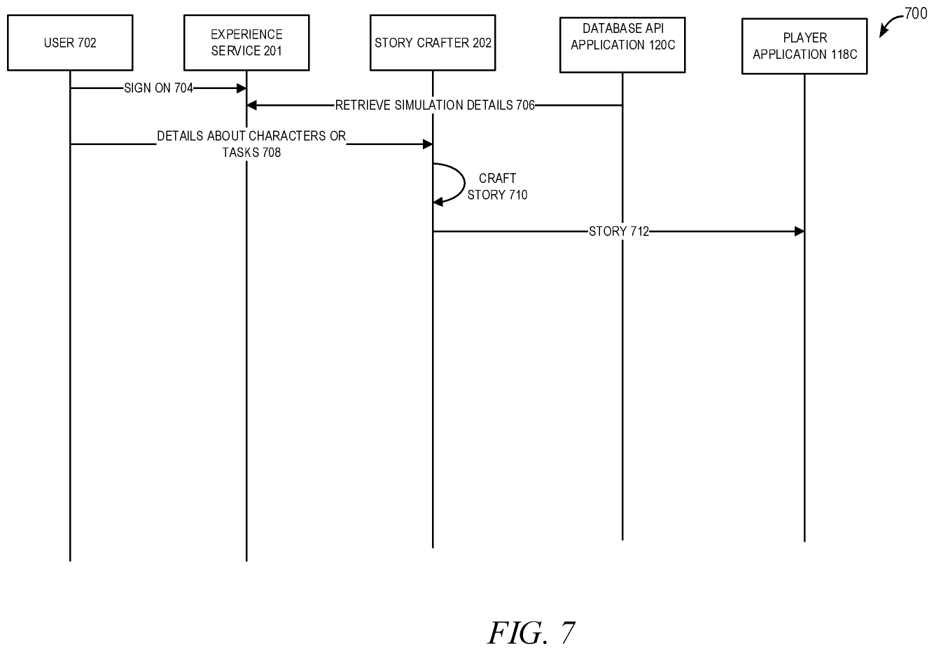

FIG. 7 is a sequence diagram illustrating a method 700 of creating a story, in accordance with an example embodiment. The method 700 involves a user 702, the experience service 201, the story crafter 202, the database API application 120C, and the player application 118C. At operation 704, the user 702 signs on to the experience service 201. At operation 706, details about the simulation are retrieved via the database API application 120C. At operation 708, the user 702 provides details about characters or tasks to be completed to the story crafter 202. This may include providing images or videos that support the story narrative. At operation 710, the story crafter 202 crafts the story and at operation 712, the story is sent to the player application 118C.

When the simulation is run, the simulator application 120A runs the simulation and presents information about the running simulation to the player application 118C, which renders it for users via the extended reality engine 208. The users are also able to view analytics about the running application, such as metrics about the organization process's efficiency and effectiveness from the analytics application 118B. The users are then able to rerun the simulation using different parameters.

An example of usage of the simulator will now be provided. In this example, a downstream diesel delivery service is provided. The goal is to simulate a primary/secondary distribution of diesel fuel from a pipeline terminal to gas stations to show how large numbers of distributions can be managed using ERP software, solving problems during the journey. Entities involved in the organization process include Leo's service station, where Leo is the owner and manual order initiator, Matt's service station, where Matt is the owner and automatic order initiator, and ACME Petroleum, where Angelica is a dispatcher, Sergio is a planner, and Priya is a scheduler. Locations used in the organization process include Leo's service station, Matt's service station, 8-10 other service stations, 2-3 other industrial customers, a refinery, a smart city terminal with a parking lot for tanker trucks, and roads with traffic.

The world may be designed with various elements, including landmarks (fixed elements), agents (moving elements), and animations (fixed movement). Examples of landmarks include a refinery, pipeline terminal with parking lot, storage tanks, service stations, and industrial customers. Examples of agents include tanker trucks and consumer vehicles. Examples of animations include tanker truck loading, tanker truck unloading, car choosing a pump, and car refueling.

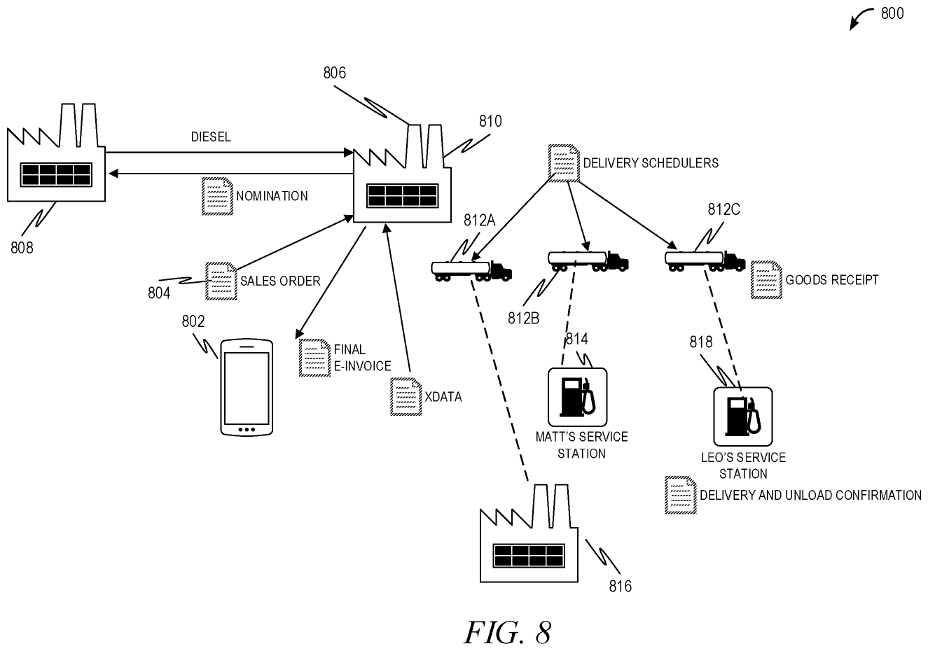

FIG. 8 is a block diagram illustrating a document flow 800 for the downstream diesel delivery, in accordance with an example embodiment. Here, the user may utilize mobile device 802 to generate a sales order 804 to Acme Petroleum 806, which nominates supplier 808 to obtain diesel fuel. Acme Petroleum 806 then creates delivery schedules 810, which are used by tanker trucks 812A, 812B, 812C to deliver fuel to Matt's service station 814, Point A Industrial customer 816, and Leo's service station 818.

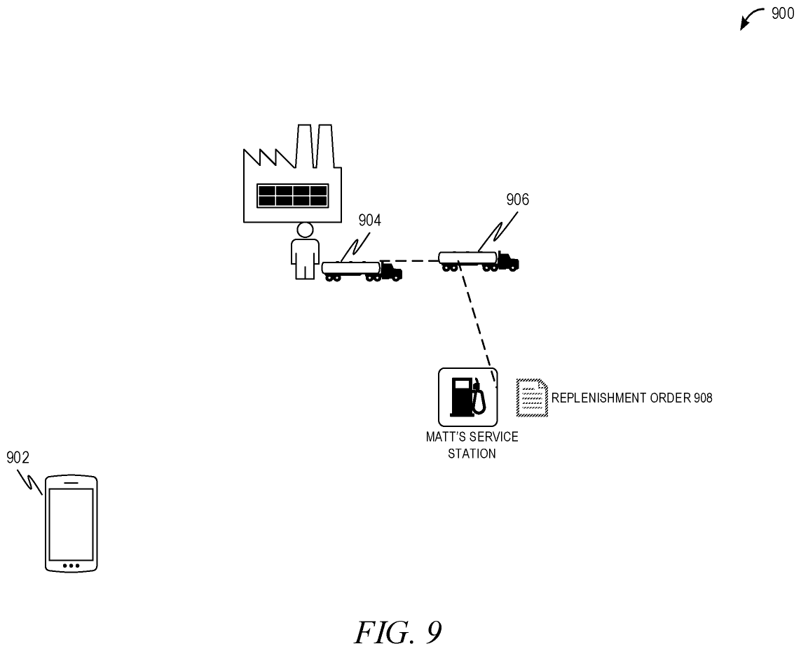

FIG. 9 is a block diagram illustrating a process flow 900 for an experience, in accordance with an example embodiment. The processes in this flow may be depicted visually to a user via the extended reality engine 208. Here, a user of device 902 may view the extended reality experience as a 3D world. Displayed may be various animations in appropriate locations and at appropriate times, such as animation 904 depicting a person loading a tanker truck with fuel, an exact location of the tanker truck 906 via GPS coordinates, and a stock low alert 908 at Matt's service station that triggers a replenishment order automatically.

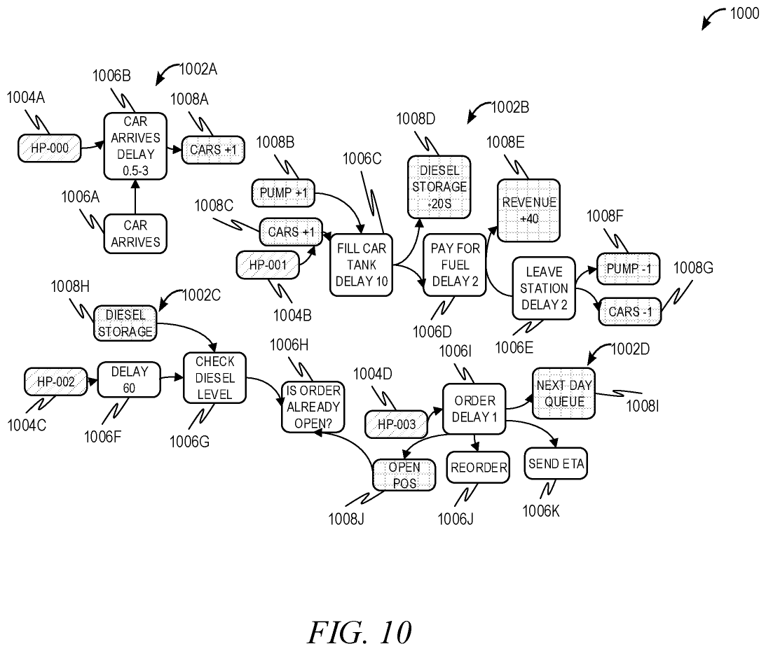

FIG. 10 is a block diagram illustrating a simulation model 1000, where the steps of the corresponding organization models complete without disruption, in accordance with an example embodiment. Here, there are four organization processes 1002A, 1002B, 1002C, 1002D depicted. The names of each of the organization processes 1002A, 1002B, 1002C, 1002D are represented by nodes 1004A, 1004B, 1004C, 1004D, respectively. Nodes 1006A, 1006B, 1006C, 1006D, 1006E, 1006F, 1006G, 1006H, 1006I, 1006J, 1006K, represent activities within the organization processes 1002A, 1002B, 1002C, 1002D. Nodes 1008A, 1008B, 1008C, 1008D, 1008E, 1008F, 1008G, 1008H, 1008I, 1008J represent resource changes from the corresponding activities. Notably, the organization processes 1002A, 1002B, 1002C, 1002D are not completely distinct from one another, with organization process 1002D connecting to organization process 1002C via node 1006I.

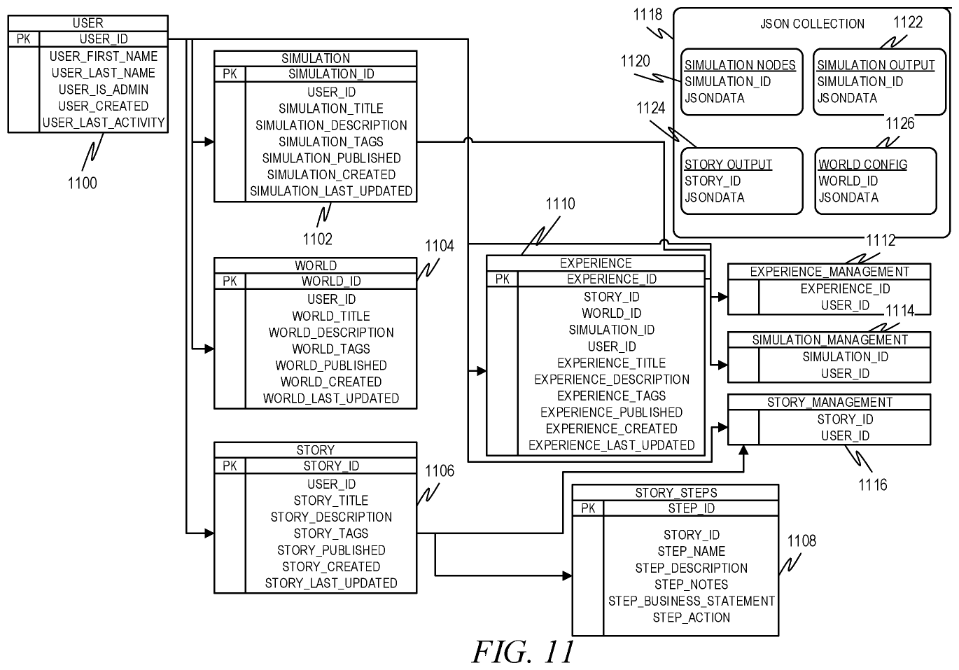

FIG. 11 is a diagram illustrating a plurality of data structures used to implement the simulations, in accordance with an example embodiment. The data structures include a user table 1100 for each user, a simulation table 1102 for each simulation, a world table 1104 for each world, a story table 1106 for each story, a story steps table 1108 for each story step in each story, an experience table 1110 for each experience, an experience management table 1112, a simulation management table 1114, and a story management table 1116. Also depicted are data structures in a JSON collection 1118, namely a simulation nodes data structure 1120, a simulation output data structure 1122, a story output data structure 1124, and a world configuration data structure 1126.

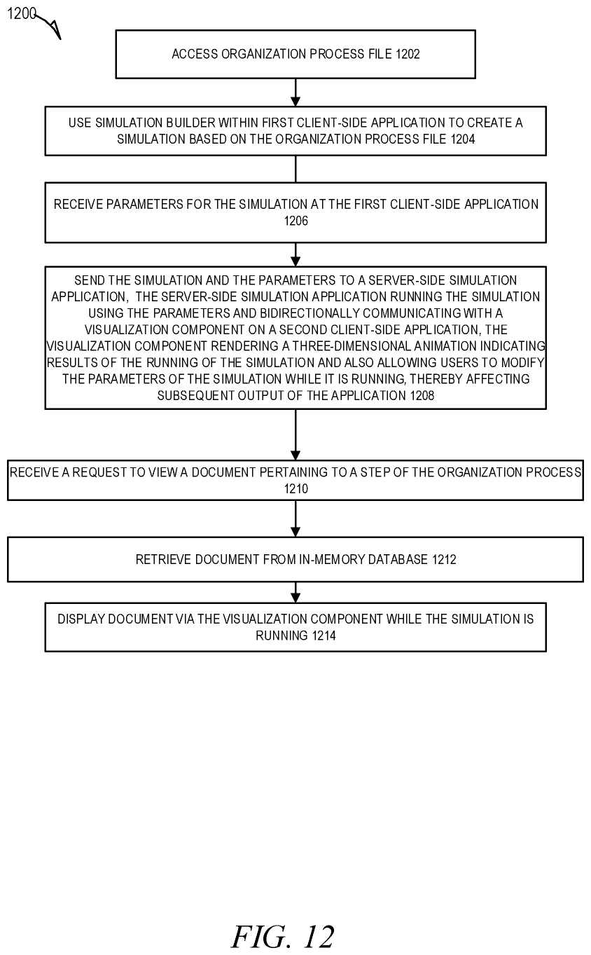

FIG. 12 is a flow diagram illustrating a method 1200 of simulating an organization process, in accordance with an example embodiment. At operation 1202, an organization process file is accessed at a first client-side application. The organization process file contains a graphical depiction of steps in an organization process, decision flows between the steps, and entity types that perform the steps. At operation 1204, a simulation builder within the first client-side application is used to create a simulation based on the organization process file. At operation 1206, parameters for the simulation are received at the first client-side application, the parameters indicating identifications of specific entities, of the entity type, corresponding to the steps. At operation 1208, the simulation and the parameters are sent to a server-side simulation application, the server-side simulation application running the simulation using the parameters and bidirectionally communicating with a visualization component on a second client-side application, the visualization component rendering a 3D animation indicating results of the running of the simulation and also allowing users to modify the parameters of the simulation while it is running, thereby affecting subsequent output of the application.

At operation 1210, a request from a user is received during the running of the simulation, via the visualization component, the request being a request to view a document pertaining to a step of the organization process. In response to the receiving, the document is retrieved from an in-memory database at operation 1212. At operation 1214, the document is displayed to the user via the visualization component while the simulation is running.

In view of the above-described implementations of subject matter, this application discloses the following list of examples, wherein one feature of an example in isolation or more than one feature of said example taken in combination and, optionally, in combination with one or more features of one or more further examples are further examples also falling within the disclosure of this application:

Example 1. A system comprising:
at least one hardware processor; and
a computer-readable medium storing instructions that, when executed by the at least one hardware processor, cause the at least one hardware processor to perform operations comprising:
accessing, at a first client-side application, an organization process file, the organization process file defining a graphical depiction of steps in an organization process, decision flows between the steps, and entity types that perform the steps;
utilizing a simulation builder within the first client-side application to create a simulation based on the organization process file;
receiving, at the first client-side application, parameters for the simulation, the parameters indicating identifications of specific entities, of the entity type, corresponding to the steps; and
sending the simulation and the parameters to a server-side simulation application, the server-side simulation application configured to run the simulation using the parameters and bidirectionally communicate with a visualization component on a second client-side application, the visualization component configured to render a three-dimensional animation indicating results of the running of the simulation and also allowing users to modify the parameters of the simulation while it is running, thereby affecting subsequent output of the application.

Example 2. The system of Example 1, wherein the organization process file is a BPMN file.

Example 3. The system of Examples 1 or 2, wherein the visualization component further displays one or more metrics of the organization process during the running of the simulation.

Example 4. The system of any of Examples 1-3, wherein the operations further comprise:
receiving, during the running of the simulation, a request from a user, via the visualization component, to view a document pertaining to a step of the organization process; and
in response to the receiving:
   retrieving the document from an in-memory database; and
displaying the document to the user via the visualization component while the simulation is running.

Example 5. The system of Example 4, wherein the document is an invoice generated during the running of the simulation to one or more of the specific entities specified in the parameters.

Example 6. The system of any of Examples 1-5, wherein the running of the simulation further comprises running time forward in the simulation at an accelerated pace based on the parameters, with the visualization component rendering the 3D animation at a speed matching the accelerated pace of the simulation.

Example 7. The system of any of Examples claim 1-6, wherein the running of the simulation includes generating random events using consistent random streams.

Example 8. A method comprising:
accessing, at a first client-side application, an organization process file, the organization process file defining a graphical depiction of steps in an organization process, decision flows between the steps, and entity types that perform the steps;
utilizing a simulation builder within the first client-side application to create a simulation based on the organization process file;
receiving, at the first client-side application, parameters for the simulation, the parameters indicating identifications of specific entities, of the entity type, corresponding to the steps; and
sending the simulation and the parameters to a server-side simulation application, the server-side simulation application configured to run the simulation using the parameters and bidirectionally communicate with a visualization component on a second client-side application, the visualization component configured to render a three-dimensional animation indicating results of the running of the simulation and also allowing users to modify the parameters of the simulation while it is running, thereby affecting subsequent output of the application.

Example 9. The method of Example 8, wherein the organization process file is a BPMN file.

Example 10. The method of Examples 8 or 9, wherein the visualization component further displays one or more metrics of the organization process during the running of the simulation.

Example 11. The method of any of Examples 8-10, further comprising:
receiving, during the running of the simulation, a request from a user, via the visualization component, to view a document pertaining to a step of the organization process; and
in response to the receiving:
   retrieving the document from an in-memory database; and
displaying the document to the user via the visualization component while the simulation is running.

Example 12. The method of Example 11, wherein the document is an invoice generated during the running of the simulation to one or more of the specific entities specified in the parameters.

Example 14. The method of any of Examples 8-12, wherein the running of the simulation further comprises running time forward in the simulation at an accelerated pace based on the parameters, with the visualization component rendering the 3D animation at a speed matching the accelerated pace of the simulation.

Example 14. The method of any of Examples 8-13, wherein the running of the simulation includes generating random events using consistent random streams.

Example 15. A non-transitory machine-readable medium storing instructions which, when executed by one or more processors, cause the one or more processors to perform operations comprising:
accessing, at a first client-side application, an organization process file, the organization process file defining a graphical depiction of steps in an organization process, decision flows between the steps, and entity types that perform the steps;
utilizing a simulation builder within the first client-side application to create a simulation based on the organization process file;
receiving, at the first client-side application, parameters for the simulation, the parameters indicating identifications of specific entities, of the entity type, corresponding to the steps; and
sending the simulation and the parameters to a server-side simulation application, the server-side simulation application configured to run the simulation using the parameters and bidirectionally communicate with a visualization component on a second client-side application, the visualization component configured to render a three-dimensional animation indicating results of the running of the simulation and also allowing users to modify the parameters of the simulation while it is running, thereby affecting subsequent output of the application.

Example 16. The non-transitory machine-readable medium of claim 15, wherein the organization process file is a BPMN file.

Example 17. The non-transitory machine-readable medium of Examples 15 or 16, wherein the visualization component further displays one or more metrics of the organization process during the running of the simulation.

Example 18. The non-transitory machine-readable medium of any of Examples 15-17, wherein the operations further comprise:
receiving, during the running of the simulation, a request from a user, via the visualization component, to view a document pertaining to a step of the organization process; and
in response to the receiving:
   retrieving the document from an in-memory database; and
displaying the document to the user via the visualization component while the simulation is running.

Example 19. The non-transitory machine-readable medium of Example 18, wherein the document is an invoice generated during the running of the simulation to one or more of the specific entities specified in the parameters.

Example 20. The non-transitory machine-readable medium of any of Examples 15-19, wherein the running of the simulation further comprises running time forward in the simulation at an accelerated pace based on the parameters, with the visualization component rendering the 3D animation at a speed matching the accelerated pace of the simulation.

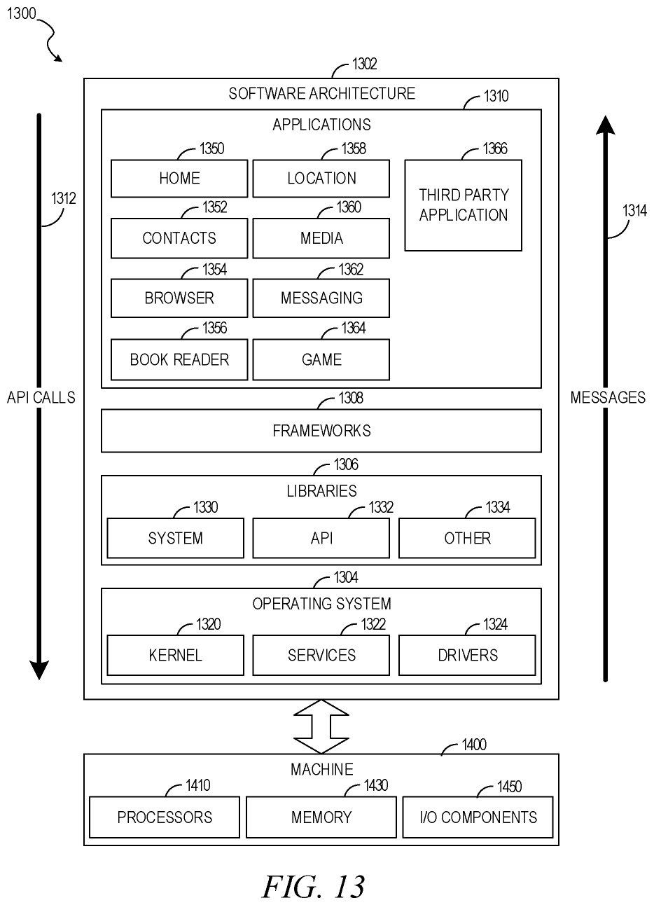

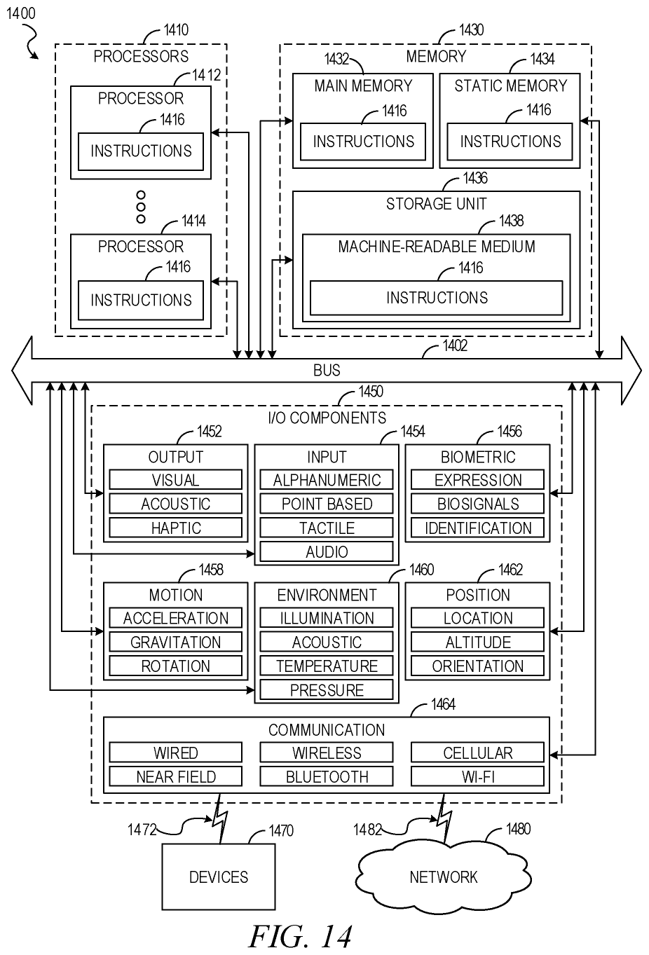

FIG. 13 is a block diagram 1300 illustrating a software architecture 1302, which can be installed on any one or more of the devices described above. FIG. 13 is merely a non-limiting example of a software architecture, and it will be appreciated that many other architectures can be implemented to facilitate the functionality described herein. In various embodiments, the software architecture 1302 is implemented by hardware such as a machine 1400 of FIG. 14 that includes processors 1410, memory 1430, and input/output (I/O) components 1450. In this example architecture, the software architecture 1302 can be conceptualized as a stack of layers where each layer may provide a particular functionality. For example, the software architecture 1302 includes layers such as an operating system 1304, libraries 1306, frameworks 1308, and applications 1310. Operationally, the applications 1310 invoke API calls 1312 through the software stack and receive messages 1314 in response to the API calls 1312, consistent with some embodiments.

In various implementations, the operating system 1304 manages hardware resources and provides common services. The operating system 1304 includes, for example, a kernel 1320, services 1322, and drivers 1324. The kernel 1320 acts as an abstraction layer between the hardware and the other software layers, consistent with some embodiments. For example, the kernel 1320 provides memory management, processor management (e.g., scheduling), component management, networking, and security settings, among other functionality. The services 1322 can provide other common services for the other software layers. The drivers 1324 are responsible for controlling or interfacing with the underlying hardware. For instance, the drivers 1324 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 1306 provide a low-level common infrastructure utilized by the applications 1310. The libraries 1306 can include system libraries 1330 (e.g., C standard library) that can provide functions such as memory allocation functions, string manipulation functions, mathematic functions, and the like. In addition, the libraries 1306 can include API libraries 1332 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two-dimensional (2D) and 3D in a graphic context on a display), database libraries (e.g., SQLite to provide various relational database functions), web libraries (e.g., WebKit to provide web browsing functionality), and the like. The libraries 1306 can also include a wide variety of other libraries 1334 to provide many other APIs to the applications 1310.

The frameworks 1308 provide a high-level common infrastructure that can be utilized by the applications 1310. For example, the frameworks 1308 provide various graphical user interface functions, high-level resource management, high-level location services, and so forth. The frameworks 1308 can provide a broad spectrum of other APIs that can be utilized by the applications 1310, some of which may be specific to a particular operating system 1304 or platform.

In an example embodiment, the applications 1310 include a home application 1350, a contacts application 1352, a browser application 1354, a book reader application 1356, a location application 1358, a media application 1360, a messaging application 1362, a game application 1364, and a broad assortment of other applications, such as a third-party application 1366. The applications 1310 are programs that execute functions defined in the programs. Various programming languages can be employed to create one or more of the applications 1310, structured in a variety of manners, such as object-oriented programming languages (e.g., Objective-C, Java, or C++) or procedural programming languages (e.g., C or assembly language). In a specific example, the third-party application 1366 (e.g., an application developed using the ANDROID™ or IOS™ software development kit (SDK) by an entity other than the vendor of the particular platform) may be mobile software running on a mobile operating system such as IOS™, ANDROID™ WINDOWS® Phone, or another mobile operating system. In this example, the third-party application 1366 can invoke the API calls 1312 provided by the operating system 1304 to facilitate functionality described herein.

FIG. 14 illustrates a diagrammatic representation of a machine 1400 in the form of a computer system within which a set of instructions may be executed for causing the machine 1400 to perform any one or more of the methodologies discussed herein. Specifically, FIG. 14 shows a diagrammatic representation of the machine 1400 in the example form of a computer system, within which instructions 1416 (e.g., software, a program, an application, an applet, an app, or other executable code) cause the machine 1400 to perform any one or more of the methodologies discussed herein to be executed. For example, the instructions 1416 may cause the machine 1400 to execute the method of FIG. 12. Additionally, or alternatively, the instructions 1416 may implement FIGS. 1-12 and so forth. The instructions 1416 transform the general, non-programmed machine 1400 into a particular machine 1400 programmed to carry out the described and illustrated functions in the manner described. In alternative embodiments, the machine 1400 operates as a standalone device or may be coupled (e.g., networked) to other machines. In a networked deployment, the machine 1400 may operate in the capacity of a server machine or a client machine in a server-client network environment, or as a peer machine in a peer-to-peer (or distributed) network environment. The machine 1400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1416, sequentially or otherwise, that specify actions to be taken by the machine 1400. Further, while only a single machine 1400 is illustrated, the term “machine” shall also be taken to include a collection of machines 1400 that individually or jointly execute the instructions 1416 to perform any one or more of the methodologies discussed herein.

The machine 1400 may include processors 1410, memory 1430, and I/O components 1450, which may be configured to communicate with each other such as via a bus 1402. In an example embodiment, the processors 1410 (e.g., a CPU, a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1412 and a processor 1414 that may execute the instructions 1416. The term “processor” is intended to include multi-core processors that may comprise two or more independent processors (sometimes referred to as “cores”) that may execute instructions 1416 contemporaneously. Although FIG. 14 shows multiple processors 1410, the machine 1400 may include a single processor 1412 with a single core, a single processor 1412 with multiple cores (e.g., a multi-core processor 1412), multiple processors 1412, 1414 with a single core, multiple processors 1412, 1414 with multiple cores, or any combination thereof.

The memory 1430 may include a main memory 1432, a static memory 1434, and a storage unit 1436, each accessible to the processors 1410 such as via the bus 1402. The main memory 1432, the static memory 1434, and the storage unit 1436 store the instructions 1416 embodying any one or more of the methodologies or functions described herein. The instructions 1416 may also reside, completely or partially, within the main memory 1432, within the static memory 1434, within the storage unit 1436, within at least one of the processors 1410 (e.g., within the processor's cache memory), or any suitable combination thereof, during execution thereof by the machine 1400.

The I/O components 1450 may include a wide variety of components to receive input, provide output, produce output, transmit information, exchange information, capture measurements, and so on. The specific I/O components 1450 that are included in a particular machine will depend on the type of machine. For example, portable machines such as mobile phones will likely include a touch input device or other such input mechanisms, while a headless server machine will likely not include such a touch input device. It will be appreciated that the I/O components 1450 may include many other components that are not shown in FIG. 14. The I/O components 1450 are grouped according to functionality merely for simplifying the following discussion, and the grouping is in no way limiting. In various example embodiments, the I/O components 1450 may include output components 1452 and input components 1454. The output components 1452 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1454 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1450 may include biometric components 1456, motion components 1458, environmental components 1460, or position components 1462, among a wide array of other components. For example, the biometric components 1456 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1458 may include acceleration sensor components (e.g., accelerometer), gravitation sensor components, rotation sensor components (e.g., gyroscope), and so forth. The environmental components 1460 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1462 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1450 may include communication components 1464 operable to couple the machine 1400 to a network 1480 or devices 1470 via a coupling 1482 and a coupling 1472, respectively. For example, the communication components 1464 may include a network interface component or another suitable device to interface with the network 1480. In further examples, the communication components 1464 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1470 may be another machine or any of a wide variety of peripheral devices (e.g., coupled via a USB).

Moreover, the communication components 1464 may detect identifiers or include components operable to detect identifiers. For example, the communication components 1464 may include radio-frequency identification (RFID) tag reader components, NFC smart tag detection components, optical reader components (e.g., an optical sensor to detect one-dimensional bar codes such as Universal Product Code (UPC) bar codes, multi-dimensional bar codes such as QR code, Aztec codes, Data Matrix, Dataglyph, Maxi Code, PDF417, Ultra Code, UCC RSS-2D bar code, and other optical codes), or acoustic detection components (e.g., microphones to identify tagged audio signals). In addition, a variety of information may be derived via the communication components 1464, such as location via Internet Protocol (IP) geolocation, location via Wi-Fi® signal triangulation, location via detecting an NFC beacon signal that may indicate a particular location, and so forth.

The various memories (i.e., 1430, 1432, 1434, and/or memory of the processor(s) 1410) and/or the storage unit 1436 may store one or more sets of instructions 1416 and data structures (e.g., software) embodying or utilized by any one or more of the methodologies or functions described herein. These instructions (e.g., the instructions 1416), when executed by the processor(s) 1410, cause various operations to implement the disclosed embodiments.

As used herein, the terms “machine-storage medium,” “device-storage medium,” and “computer-storage medium” mean the same thing and may be used interchangeably. The terms refer to single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1480 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1480 or a portion of the network 1480 may include a wireless or cellular network, and the coupling 1482 may be a Code Division Multiple Access (CDMA) connection, a Global System for Mobile communications (GSM) connection, or another type of cellular or wireless coupling. In this example, the coupling 1482 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 13G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 1416 may be transmitted or received over the network 1380 using a transmission medium 1438 via a network interface device (e.g., a network interface component included in the communication components 1464) and utilizing any one of a number of well-known transfer protocols (e.g., HTTP). Similarly, the instructions 1416 may be transmitted or received using a transmission medium via the coupling 1472 (e.g., a peer-to-peer coupling) to the devices 1470. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1416 for execution by the machine 1400, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
at least one hardware processor; and
a computer-readable medium storing instructions that, when executed by the at least one hardware processor, cause the at least one hardware processor to perform operations comprising:
accessing, at a first client-side application, an organization process file, the organization process file defining a graphical depiction of steps in an organization process, decision flows between the steps, and entity types that perform the steps;
utilizing a simulation builder within the first client-side application to create a simulation based on the organization process file;
receiving, at the first client-side application, parameters for the simulation, the parameters indicating identifications of specific entities, of the entity type, corresponding to the steps; and
sending the simulation and the parameters to a server-side simulation application, the server-side simulation application configured to run the simulation using the parameters and bidirectionally communicate with a visualization component on a second client-side application, the visualization component configured to render a three-dimensional animation indicating results of the running of the simulation and also allowing users to modify the parameters of the simulation while it is running, thereby affecting subsequent output of the application.

2. The system of claim 1, wherein the organization process file is a Business Process Model and Notation (BPMN) file.

3. The system of claim 1, wherein the visualization component further displays one or more metrics of the organization process during the running of the simulation.

4. The system of claim 1, wherein the operations further comprise:
receiving, during the running of the simulation, a request from a user, via the visualization component, to view a document pertaining to a step of the organization process; and
in response to the receiving:
retrieving the document from an in-memory database; and
displaying the document to the user via the visualization component while the simulation is running.

5. The system of claim 4, wherein the document is an invoice generated during the running of the simulation to one or more of the specific entities specified in the parameters.

6. The system of claim 1, wherein the running of the simulation further comprises running time forward in the simulation at an accelerated pace based on the parameters, with the visualization component rendering the three-dimensional animation at a speed matching the accelerated pace of the simulation.

7. The system of claim 1, wherein the running of the simulation includes generating random events using consistent random streams.

8. A method comprising:
accessing, at a first client-side application, an organization process file, the organization process file defining a graphical depiction of steps in an organization process, decision flows between the steps, and entity types that perform the steps;
utilizing a simulation builder within the first client-side application to create a simulation based on the organization process file;
receiving, at the first client-side application, parameters for the simulation, the parameters indicating identifications of specific entities, of the entity type, corresponding to the steps; and
sending the simulation and the parameters to a server-side simulation application, the server-side simulation application configured to run the simulation using the parameters and bidirectionally communicate with a visualization component on a second client-side application, the visualization component configured to render a three-dimensional animation indicating results of the running of the simulation and also allowing users to modify the parameters of the simulation while it is running, thereby affecting subsequent output of the application.

9. The method of claim 8, wherein the organization process file is a Business Process Model and Notation (BPMN) file.

10. The method of claim 8, wherein the visualization component further displays one or more metrics of the organization process during the running of the simulation.

11. The method of claim 8, further comprising:
receiving, during the running of the simulation, a request from a user, via the visualization component, to view a document pertaining to a step of the organization process; and
in response to the receiving:
retrieving the document from an in-memory database; and
displaying the document to the user via the visualization component while the simulation is running.

12. The method of claim 11, wherein the document is an invoice generated during the running of the simulation to one or more of the specific entities specified in the parameters.

13. The method of claim 8, wherein the running of the simulation further comprises running time forward in the simulation at an accelerated pace based on the parameters, with the visualization component rendering the three-dimensional animation at a speed matching the accelerated pace of the simulation.

14. The method of claim 8, wherein the running of the simulation includes generating random events using consistent random streams.

15. A non-transitory machine-readable medium storing instructions which, when executed by one or more processors, cause the one or more processors to perform operations comprising:
accessing, at a first client-side application, an organization process file, the organization process file defining a graphical depiction of steps in an organization process, decision flows between the steps, and entity types that perform the steps;
utilizing a simulation builder within the first client-side application to create a simulation based on the organization process file;
receiving, at the first client-side application, parameters for the simulation, the parameters indicating identifications of specific entities, of the entity type, corresponding to the steps; and
sending the simulation and the parameters to a server-side simulation application, the server-side simulation application configured to run the simulation using the parameters and bidirectionally communicate with a visualization component on a second client-side application, the visualization component configured to render a three-dimensional animation indicating results of the running of the simulation and also allowing users to modify the parameters of the simulation while it is running, thereby affecting subsequent output of the application.

16. The non-transitory machine-readable medium of claim 15, wherein the organization process file is a Business Process Model and Notation (BPMN) file.

17. The non-transitory machine-readable medium of claim 15, wherein the visualization component further displays one or more metrics of the organization process during the running of the simulation.

18. The non-transitory machine-readable medium of claim 15, wherein the operations further comprise:
receiving, during the running of the simulation, a request from a user, via the visualization component, to view a document pertaining to a step of the organization process; and
in response to the receiving:
retrieving the document from an in-memory database; and
displaying the document to the user via the visualization component while the simulation is running.

19. The non-transitory machine-readable medium of claim 18, wherein the document is an invoice generated during the running of the simulation to one or more of the specific entities specified in the parameters.

20. The non-transitory machine-readable medium of claim 15, wherein the running of the simulation further comprises running time forward in the simulation at an accelerated pace based on the parameters, with the visualization component rendering the three-dimensional animation at a speed matching the accelerated pace of the simulation.
